(19) United States
(12) Patent Application Publication
(10) Pub. No.: US 2002/0124159 A1
(43) Pub. Date: Sep. 5, 2002

(54) Data processing apparatus

(76) Inventors: Marco Jan Gerrit Bekooji, Eindhoven (NL); Albert Van Der Werf, Eindhoven (NL); Natalino Giorgio Busa, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 09/994,364

(22) Filed: Nov. 26, 2001

(30) Foreign Application Priority Data
Nov. 27, 2000 (EP) 00204202.6

(51) Int. Cl. G06F 9/00

(52) U.S. Cl. 712/226; 712/215; 712/216

(57) ABSTRACT

A data processing apparatus executes a program. A number of operations has to be executed at a data dependent points in time. This is implemented by executing a data independent series of instructions at data independent points in time. The series of instructions includes instructions whose completion is dependent on data dependent conditions. Using the conditions it is selected which of the executed instructions cause the operations to be executed. FIG. 1

The invention relates to a data processing apparatus.

The number of instruction cycles that a program needs to produce the results of a processing function often varies for different executions of the program. Often, it depends on the data how many instruction cycles a program needs to produce a result. For example, for the purpose of variable length encoding, it depends on the data how many data input cycles must be performed before a complete output word is produced. Another example of a function that produces results after a variable time occurs when relevant data must be identified in stream of input data before a result can be produced.

The need to handle data that is produced after a non-predetermined time leads to the use of conditional branch instructions in programs. Suppose that the program contains a follow-up instruction that uses the result of a processing function, which requires a data dependent number of instruction cycles. The program will then normally contain a conditional branch instruction to branch to the follow-up instruction once the processing function has produced the result. However, the use of conditional branch instructions is disadvantageous, because it slows down program execution if the processing apparatus is not able to predict the correct branch. In the case of functions that have a data dependent behavior it is specifically difficult to predict the outcome of such branches correctly.

In dedicated data stream processors this problem has been overcome by using different processing elements for producing and consuming of results, and interfacing the processors by a handshaking mechanism. The producer outputs a signal to indicate when a result is available and the consumer starts execution dependent on that signal. Thus, the consumer is ensured to process the result, but it is not known in advance in which processing cycle this will occur. Although such a dedicated processor doesn't have the problems associated with branch instructions, this dedicated processor avoids these problems at the expense of flexibility compared to an instruction processor: a dedicated producer and consumer of data are required, connected by a handshake interface. Such dedicated processors don't have the flexibility to execute a program, executing a different program instruction in each processing cycle.

Amongst others, it is an object of the invention to reduce the number of conditional branches needed when a flexible instruction processing apparatus executes a processing function that requires a run-time variable number of instruction cycles.

A processing apparatus according to the invention is set forth in claim 1. According to the invention the program of the processing apparatus provides for performing one or more operations on respective data-items. The program controls issuing of a number of conditionally executable instructions for causing the apparatus to perform these operations or this operation. A conditionally executable instruction is a machine instruction that has an operand that controls whether or not the operation specified by the instruction is to be performed completely. Examples of such conditionally executable instructions are “guarded instructions”, as described in PCT patent application No. 96/21186.

The number of conditionally executable instructions that the program is designed to issue sequentially during program flow is greater than the number of operations that these instructions have to cause to be performed. The conditionally executable instructions are issued in different processing cycles, that is, sequentially in a sense that does not exclude that other instructions are issued in between. Sequential issue of a surplus of instructions allows data dependent selection of those of the issued instructions that are actually used to cause performance of the operations, dependent on whether the data-items for the operations are available.

The program need not “know” which of the instructions actually cause performance of the operations and which instructions do not cause performance. Program flow does not need to be affected by the selection of those instructions that cause the operations to be performed, thus avoiding the need for conditional branch instructions. Once all conditionally executable instructions have been issued, so that it is ensured that all the required operations have been executed, program flow may proceed to the execution of further instructions.

It is true that the invention requires issuing a greater number of instructions for performing the operations than if the instructions are executed only when reached via by a conditional branch instruction that is responsive to the availability of the data-item. However, it has been found that the overhead of additional instructions for performing the operations is usually less than the overhead caused by executing conditional branch instructions.

In an embodiment of the data processing apparatus of the invention a signal is used that determines which of the issued instructions should be used to execute the operations. The signal is stored in an addressable storage location, such as a register in a register file. The conditionally executable instructions have an operand that refers to the storage location and cause the signal to be read from the storage location. In a further embodiment, the signal and the data-item are produced and written to the storage locations in response to further instructions in the program. In a yet further embodiment, the signal and the data-item are written together in response to the same further instruction. Preferably, a functional unit with different outputs for writing the data-item and the signal to the addressable storage locations is provided for this purpose.

In an embodiment of the data processing apparatus according to the invention the program contains a program loop with a body of instructions that is executed a first number of times. The loop contains a copy of the conditionally executable instruction. Execution of the loop causes the copy to be issued the first number of times. Dependent on data a run time selection is made as to which of issued copies are used to perform the required operations. Several conventional techniques are known per se for making program loops, such as including a branch back instruction at the end of the body to branch back to the start of the body as long as a counter signals that the loop has not yet been executed the first number of times. But other techniques may also be used, like a repeat instruction at the start of the loop, or a branch back instruction conditional on completion of a sufficient number of the operations.

In an embodiment of the data processing system according to the invention, the complete execution of the operations is dependent on a state reached during execution of the program. The state may be represented by the content of an addressable storage location, such as a register in a register file, or by an internal state of a functional unit. An example of a state is a state represented by a counter, which counts whether a sufficient amount of information has been received to generate a next data-item. In this case the counter assumes increasing count values until a maximum count is reached, after which a new data-item is generated for processing, a corresponding signal is generate to indicate that the new data-item is available and the counter is reset.

The invention also relates to a method of operating such a data processing apparatus, a program for programming such a data processing apparatus and an apparatus designed to be able to execute such programs.

These and other advantageous aspects of the data processing apparatus according to the invention will be described in more detail using the following figures.

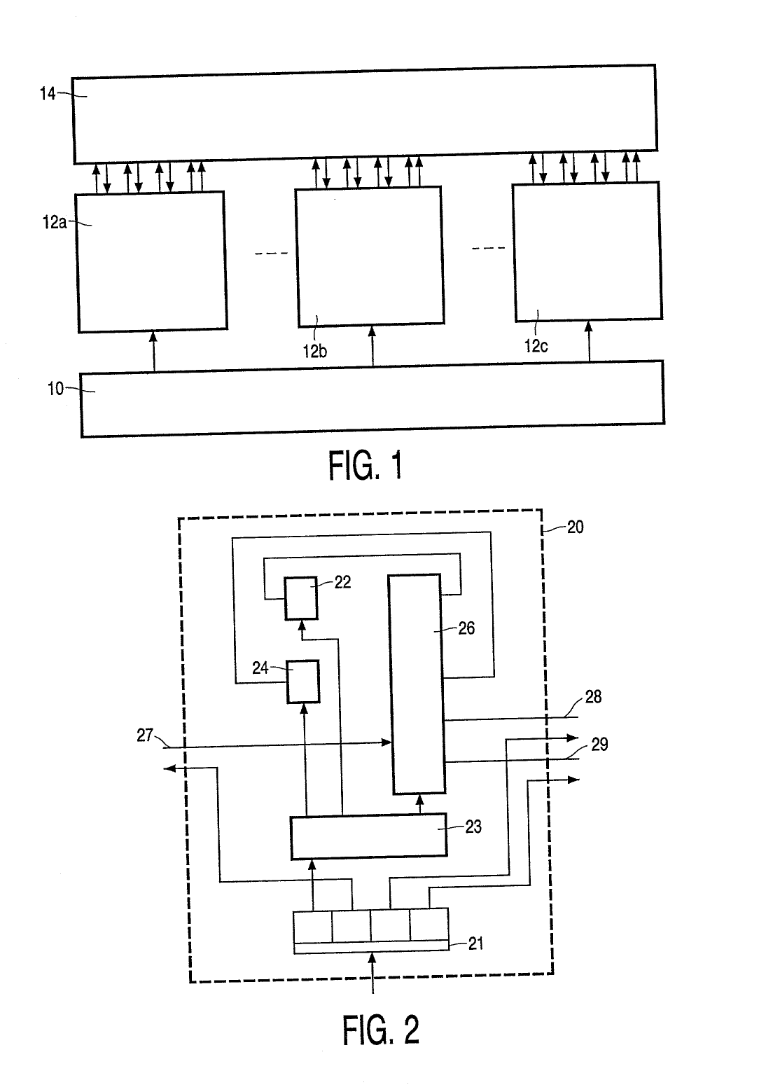

FIG. 1 shows a data processing apparatus;

FIG. 2 symbolically illustrates operation of the data processing apparatus.

FIG. 1 shows a data processing apparatus. The apparatus contains an instruction issue unit 10, functional units 12a-c and a register file 14. The instruction issue unit 10 contains a program of instructions for the functional units 12a-c. The instruction issue unit 10 typically contains an instruction memory for storing the program and a program counter (not shown). The instruction issue unit 10 has instruction outputs coupled to the functional units 12a-c. The functional units 12a-c have read write ports coupled to the register file 14. One of the functional units 12c is a branching unit with an output coupled to the instruction issue unit 10.

In operation, the instruction issue unit 10 issues successive instructions of the program to the functional units 12a-c. In response, the functional units 12a-c execute the operations commanded by the instructions, accessing operand and result data from the register file as programmed in the instructions. Table I shows machine instructions of a hypothetical prior art program for execution on a data processing apparatus.

TABLE I
(prior art program)

| | | | |
|---|---|---|---|
| 1 | | LD | #M, R1 |
| 2 | LOOP: | I1 | Rx, Ry, Ru |
| 3 | RETRY: | I2 | R3, Ru, R4 |
| 4 | | I3 | R3, Ru, R3 |
| 5 | | BNE | R4, #0, RETRY |
| 6 | | I4 | R3, R5, R5 |
| 7 | | I5 | R3, R6, R7 |
| 8 | | DEC | R1, R1 |
| 9 | END: | BGT | LOOP |
| 10 | | I6 | |

It should be noted that this program is merely intended for illustrating the principles of the invention. The exact nature of most of the instructions is not relevant for this principle and therefore not discussed. The same goes for the purpose of the program as a whole.

The instructions show a loop of instructions that is executed M times (M being an integer dependent on the application of the program). During the loop a result is produced and processed. The start the LOOP is labeled by the label “LOOP” and the end of the loop is labeled by the label “END”. The loop contains numbered instructions. The instructions specify (1) operations, (2) one or more registers that contain operands to be used in those operations and (3) one or more registers for storing the results of those operations. All registers are located in register file 14. For example, a first instruction I1 has input operands stored in registers referred to by Rx, Ry. The first instruction I1 produces a result that is stored in a register referred to by Ru.

The loop contains an instruction I3, which produces a result that is stored in the register R3. However, instruction I3 does not always produce a valid result. For example, in case I3 is a variable length compression instruction a result is produced only if the register is full. This depends on the value of the input data. The validity of the result stored in register R3 is determined with another instruction I2. This instruction I2 produces a result in a register R4, where the result represents a yes/no decision whether the result produced by I3 is valid (e.g. with a value 0 if the result in R3 is not valid and a value 1 if the result in R3 is valid). The result of instruction I2 in R4 is tested in a branch instruction (numbered instruction 5). If the result indicates that R3 does not (yet) contain valid data, this instruction branches back to the instruction I2, which is labeled with the label “RETRY”. If the result indicates that R3 contains valid data the branch instruction does not branch. This means that subsequent instructions (I4, I5, DEC, BGT numbered 6, 7, 8 and 9) are executed. Instructions I4, I5 process the result of instruction I2. The instruction DEC decrements the loop counter, which is stored in the register referred to by R1. The instruction BGT branches back to the start of the loop (labeled “LOOP”) if the loop counter is not yet zero. Otherwise, the program proceeds with the execution of instruction I6 and so on.

Thus, the loop ensures that M valid results will be produced by instruction I3 and processed by instructions I4, I5. The branch instruction BNE ensures that when no valid result is produced, I2 and I3 are repeated until a valid result is produced.

The execution of the program shown in table I can be inefficient. This is a consequence of the branch instructions in combination with instruction prefetching and/or pipelining. Many processors improve efficiency fetching instructions by fetching instructions before the preceding instructions have been completely executed. Thus, the instructions can be executed sooner than if fetching occurs only after completion of execution of the preceding instruction. This is implemented in the instruction issue unit 10. The instruction issue unit computes the address of successive instructions, fetches these instructions and issues them successively to the functional units 12a-c. Also some further steps of instruction execution may be performed before the preceding instruction is completely executed, leading to a further speed-up.

However, when a conditional branch instruction is executed all this gain may be lost. It is not clear in advance which instruction will be executed after the conditional branch condition. The instruction issue unit 10 has to make a prediction which instruction will be executed after the conditional branch instruction and it will fetch that instruction. If the prediction is wrong, the correct instruction will have to be fetched and any effect of fetching the incorrect instruction will have to be undone.

In the case of the program of table I the branch instruction that depends on the validity of the result of I3 leads to much loss of efficiency, much more than the branch instruction at the end of the loop (BGT). The branch instruction (BGT) at the end of the loop is usually taken. Therefore, after fetching this branch instruction the instruction issue unit 10 will normally fetch the instruction at the target “LOOP” of this branch instruction. If M=100 for example, this will lead to a loss of efficiency for only 1% of the branches. This is different, however, for the branch instruction that depends on the validity of the result of instruction I3. Here, the probability of one branch or the other is for example 50%, leading to a loss of efficiency in 50% of the executions.

Table II shows a program that reduces this problem. (Once again it should be noted that this program is merely intended for illustrating the principles of the invention. The exact nature of most of the instructions is not discussed when the nature is irrelevant for this principle. The same goes for the purpose of the program as a whole.)

TABLE II

| | | | |
|---|---|---|---|
| 1 | | LD | #N, R1 |
| 2 | LOOP: | I1 | Rx, Ry, Ru |
| 3 | | I2 | R3, Ru, R4 |
| 4 | | I3 | R3, Ru, R3 |
| 5 | | CI4 | R4, R3, R5, R5 |
| 6 | | CI5 | R4, R3, R6, R7 |
| 7 | | DEC | R1, R1 |
| 8 | END: | BGT | LOOP |
| 9 | | I6 | |

Comparing the program of table II with the program of table I, the branch back instruction BNE has been removed. Instructions I4 and I5 have been replaced by conditionally executable instructions CI4, CI5 and the loop count M (of the number of results that must be produced) has been replaced by N (the number of times the loop must be executed; M<N).

The conditionally executable instructions CI4, CI5 are executed for example by functional unit 12a. Functional unit 12a has inputs coupled to the register file 14 for receiving two operands and a guard value. From instruction issue unit 10, functional unit 12a receives a conditionally executable instruction, like CI4, which specifies a guard register (e.g. R4), two operand registers (e.g. R3, R5) and a result register (e.g. R7). In response to the instruction. In response to the conditionally executable instruction, the content of the specified guard register and the operand registers is fetched from the register file (this fetching may be implemented by signals supplied from the instruction issue unit 10 directly to the register file 14, or from the functional unit 12a). The functional unit 12a receives the content from the register file 14 and starts executing the operation commanded by the conditionally executable instruction. If the content of the guard register a value that signifies that the operation should not be executed, completion of execution of the operation is disabled, at least before any result is written to the result register. If the content of the guard register a value that signifies that the operation should be executed, execution of the operation is completed normally.

By using conditionally executable instructions CI4, CI5 it is ensured that execution of instructions CI4, CI5 is completed only when the content of register R4 indicates that the content of register R3 is valid. That is, the program forces that these instructions CI4, CI5 are taken into execution irrespective of whether are valid new data is available and the instruction issue unit 10 issues these instructions CI4, CI5 irrespective of whether valid new data is available. It is the functional unit 12a that determines whether the execution is completed, on the basis of the content of the register R4 that is specified as guard register in these instructions CI4, CI5. It should be noted that, although in the example of table II the conditionally executable instructions CI4, CI5 both have the validated data (from register R3) as operand, the conditionally executable instructions may also include instructions with operands that results produced by processing this data, rather than this data itself.

Other instructions in the loop may be executed unconditionally. For example instructions that do not affect the outcome of the loop when they are executed more than once, such as the DEC instruction for decrementing the loop variable, the BGT instruction and instruction I1 are executed irrespective of whether valid new data is available. The number of times N that the loop is executed has been chosen equal to the number of times M that valid data will be available plus the number of times that no-valid data will be available.

As a result, it has been possible to remove the conditional branch instruction BNE of table I. That is, the instruction has been removed that causes a reduction in efficiency of program execution. The price for this is that the loop is executed more often than that valid new data becomes available, including some instructions that do not affect the outcome. It has been found that the efficiency gained by removing the conditional branch instruction generally outweighs the loss in efficiency due to this superfluous execution.

In the context of the loop it is ensured that the operations commanded by the conditionally executable instructions are executed a sufficient number of times. But it is not visible in the program code, nor from program flow, when the operations are actually executed, that is, during which pass through the loop body. It is only to be ensured that the loop is executed sufficiently often that the required number of operations are executed in some of the passes. In a simple case, such as shown in table II, it is known in advance how many (N) times the loop should be passed through before the operations have been executed M times. In this case, the loop can be controlled by a loop counter. In more complicated cases, it may be necessary to count the number of times that the loop is executed with valid data (for example using a conditionally executable DEV or INC (increment) instruction, or using R4 as an increment in a counting operation). In other cases, the number M of operations that should be executed is not known in advance. In this case some other criterion may be used to terminate the loop. In any case, after termination of the loop the program continues by executing further instructions.

Of course the invention is not limited to loops with a branch back instructions. For example, an unrolled loop could be used, where the instructions in the program include N copies of the loop body. In another alternative, N conditionally executable instructions for identical operations, from which M are selected at run-time to perform the actual M operations, could occur in mutually different program contexts.

In the example shown in table II, a data-item is produced by execution of a first instruction (13) and a signal that indicates whether the data-item represents newly valid data is produced by the execution of a second instruction (12). In another embodiment, both execution of one and the same instruction produces both the data-item and the signal. For executing such an instruction, the processing apparatus of FIG. 1 contains a functional unit 12b which has two outputs, each coupled to a respective write port to the register file 14. In operation, the instruction issue unit 10 issues an instruction to this functional unit 12b. This instruction specifies two registers in the register file 14 for storing results: one register for a data-item and one for a signal to indicate whether the data-item is newly valid. These registers are subsequently used for operands of a conditionally executable instruction, to select which of the conditionally executable instruction are used to execute the required operations.

The functional unit 12b that produces a data-item together with a signal can produce the signal in various ways. In one example, this functional unit itself receives a further signal to indicate whether its input data is newly valid. In this case the signal that indicates that the result of the instruction is valid is generated only when the further signal indicates that the input data of the instruction is newly valid. In another example, the signal depends on the input operand or operands of the instruction that produces the data-item and the signal. For example, the signal indicates that the result of the instruction is newly valid only if the value of an input operand is in a predetermined range (e.g. when the input operand is non-zero).

In a further example of such a functional unit 12b, the functional unit 12b may retain state information between execution of subsequent instructions. The functional unit 12b uses that state information to determine the value of the signal that indicates whether the data-item is newly valid. Usually, the state information also affects the operation performed by the functional unit 12b and/or the resulting data-item produced by that functional unit 12b.

FIG. 2 shows an example of a functional unit 20 that retains state information. By way of example, a functional unit 20 that performs variable length compression is shown. The functional unit 20 contains an instruction register 21, an instruction decoder 23, a first register 22, a second register 24, and an update/output unit 26. The functional unit has an operand input 27, a result data output 28 and a signal output 29. The operand input 27 of the functional unit 20 and outputs of the registers 22, 24 are coupled to respective inputs of the update/output unit 26. Respective outputs of the update/output unit 26 are coupled to inputs of the registers 22, 24 and to the result data output 28 and the signal output 29. The instruction register 21 has an input for receiving instructions from the instruction issue unit. The instruction register contains a first field for an operation code. This field is coupled to the instruction decoder 23. The instruction decoder has a control output coupled to the first and second register 22, 24 and the update/output unit 26. The instruction register 21 has a second field for an operand register address, for selecting a register from the register file, from which to read the operand. The instruction register 21 has a third and fourth field for a result register address and a signal register address respectively, for selecting a register from the register file, in which to write the result and the signal.

In operation, the functional unit 20 inputs operand values and produces result data in which a variable number of operand values have been combined, for example according to a Huffman code. The functional unit 20 builds up the result data in the first register 22 as it receives input operands. For each input operand, a number of bits are added to the result data in the first register 22, both the value of the bits and their number depending on the value of the input operand. In the second register 24 the functional unit keeps a count of the cumulative total number of bits that has been added to the result data in the first register 22. The update/output unit 24 receives the input operand, determines from the input operand the number and value of the bits that should be added to the result data, adds these bits to the result data from the first register and adds the number to the count. When this produces more bits of result data than the bit width of the result data output 28, the update/output unit 26 outputs part of the result data to the result data output 28 (leaving out the excess bits produced for the most recent input operand). Only when there is such an excess of bits the update/output unit 26 produces on signal output 29 a signal that indicates that newly valid data is available. Subsequently, the excess bits are stored in the first register 22, leaving out the bits that have been output to the result data output 28 and a count of the number of excess bits is stored in the second register 24. The precise details of the update/output unit 26 are not relevant to the invention, but this unit may contain for example a look-up table memory (not shown) addressable with the input operand, for retrieving the bits that are to be added to the result data and a number indicating the count of these bits. Furthermore the update/output unit 26 may contain a shifter (not shown) for shifting the result data concatenated with the added bits by that count. Furthermore the update/output unit 26 may contain an adder (not shown) for adding the count to the content of the second register 24.

In an embodiment, the functional unit of FIG. 2 is arranged to execute at least four types of instruction: a first type to reset the first and second register 22, 24. A second type to process an input operand as described. A third and fourth type to output the content of the first and second register 22, 24 to the register file at the end of compression. The first, third and fourth type may be combined in one type, which outputs the content of the first and second register 22, 24 on the result data output 28 and signal output 29 respectively and resets these registers 22, 24.

1. A data processing apparatus, programmed to execute a program of instructions, the program being arranged to cause the processing apparatus to issue sequentially a first number of identical, conditionally executable, non-branching instructions for causing the processing apparatus to perform a second number of operations, each operation on a respective data-item, the first number being larger than the second number, the data processing apparatus selecting which one, or ones, of the issued conditionally executable instructions cause the operation or operations on said data-items to be performed, said selecting being dependent on data processed by the apparatus.

2. A data processing apparatus according to claim 1, the conditionally executable instructions each having a first and a second operand, the first operand referring to a first storage location for storing the data-item on which the operation is to be performed, the second operand referring to a second storage location where a signal is stored that indicates whether the first storage location stores a newly valid data-item, said selecting being dependent on the signal.

3. A data processing apparatus according to claim 2, wherein the program contains further instructions, for storing the data-items and the signals for use by the conditionally executable instructions in the first and second storage locations respectively.

4. A data processing apparatus according to claim 3, comprising a functional unit for executing the further instructions, the functional unit generating each data-item together with the corresponding signal, the functional unit having outputs for writing the data-item and the signal to the first and second storage location respectively.

5. A data processing apparatus according to claim 1, the program comprising a program loop that is executed the first number of times, the program loop containing a copy of the conditionally executable instruction, said copy being issued the first number of times during execution of the program loop.

6. A data processing apparatus according to claim 1, the program being arranged to cause the processing apparatus to issue further instructions each with an operand that refers to a storage location, the further instructions making sequential updates to a state represented by a content of said storage location, each conditionally executable instructions being completely executed when the state has a predetermined state value during execution of that conditionally executable instruction.

7. A data processing apparatus according to claim 4, comprising a functional unit that has an internal state, which is sequentially updated under control of the further instructions, the functional unit setting the signal dependent on whether or not the state has reached a predetermined state value.

8. A data processing apparatus comprising
a first functional unit arranged to write a data-item and a signal indicating whether or not that data-item is a newly valid data-item to a first and second operand storage location respectively, in response to a first type of instruction;
a second functional unit arranged to execute conditionally a second type of instruction, which is a non-branching instruction, the second type of instruction having a first and second operand capable of addressing the first and second operand storage location respectively, the second functional unit executing an operation commanded by the second type of instruction on a content of the storage location addressed by the first operand, conditionally, dependent on a content of the storage location addressed by the second operand.

9. A data processing apparatus according to claim 8, the first functional unit being arranged to sequentially update an internal state in response to sequential instructions of the first type, the first functional unit being arranged to set the signal to a value indicating that the data-item is newly valid when the internal state has reached a predetermined value.

10. A method of using a data processing apparatus to execute operations or an operation, each operation on a respective data-item, the method comprising
sequentially issuing a first number of identical, conditionally executable, non-branching instructions;
run-time selecting which one, or ones, of the issued conditionally executable instructions cause the operation or operations on said data-items to be performed, said selecting being dependent on data processed by the apparatus, whereby a second number, smaller than the first number, of operations is completely executed.

11. A method according to claim 10, wherein the conditionally executable instructions have a first and a second operand, the first operand referring to a first storage location for storing the data-item on which the operation is to be performed, the second operand referring to a second storage location where a signal is stored that indicates whether the first storage location stores a newly valid data-item, said run-time selecting being dependent on the signal stored in the second storage location.

12. A computer program product comprising a computer program for executing operations or an operation, the program being arranged to cause a data processing apparatus to
sequentially issue a first number of identical, conditionally executable, non-branching instructions;
run-time select which one, or ones, of the issued conditionally executable instructions cause the operation or operations on said data-items to be performed, said selecting being dependent on data processed by the apparatus, whereby a second number, smaller than the first number, of operations is completely executed.

13. A computer program product according to claim 12, wherein the conditionally executable instructions have a first and a second operand, the first operand referring to a first storage location for storing the data-item on which the operation is to be performed, the second operand referring to a second storage location where a signal is stored that indicates whether the first storage location stores a newly valid data-item, said run-time selecting being dependent on the signal stored in the second storage location.

14. A computer program product according to claim 12, comprising a program loop that contains a copy of the conditionally executable instruction, the program being arranged to cause the processing apparatus to issue the copy the first number of times during execution of the program loop.
